(19) United States
(12) Patent Application Publication
(10) Pub. No.: US 2021/0061716 A1
(43) Pub. Date: Mar. 4, 2021

(54) POWDER FOR A THERMAL BARRIER

(71) Applicant: SAINT-GOBAIN CENTRE DE RECHERCHES ET D'ETUDES EUROPEEN, Courbevoie (FR)

(72) Inventors: Alain ALLIMANT, CAUMONTSUR DURANCE (FR); Howard WALLAR, RUTLAND, MA (US)

(21) Appl. No.: 16/965,249

(22) PCT Filed: Jan. 31, 2019
(86) PCT No.: PCT/EP2019/052443

§ 371 Date: Jul. 27, 2020

(30) Foreign Application Priority Data
Jan. 31, 2018 (FR) 1850825

(51) Int. Cl. C04B 35/486; F01D 5/28; C04B 35/653; C23C 4/11; C04B 35/626

(52) U.S. Cl. CPC C04B 35/486; F01D 5/288; C04B 35/653; C23C 4/11; C04B 2235/5463; F05D 2230/312; C04B 2235/5436; C04B 2235/3246; C04B 35/62695

(57) ABSTRACT

A powder of fused particles. The powder includes, in percentage by weight based on the oxides, more than 98% of a stabilized oxide selected from stabilized zirconium oxides, stabilized hafnium oxides and mixtures thereof, the stabilized oxide being stabilized by a stabilizer selected from the oxides of Y, Ca, Ce, Sc, Mg, In, La, Gd, Nd, Sm, Dy, Er, Yb, Eu, Pr, and Ta, called “stabilizing oxides”, and the mixtures of these stabilizing oxides. The powder has: a median particle size D₅₀ under 15 μm, a 90th percentile of the particle sizes, D₉₀, under 30 μm, and a size dispersion index (D₉₀−D₁₀)/D₁₀ below 2, and a relative density above 90%. The percentiles Dₙ of the powder are the particle sizes corresponding to the percentages, by number, of n %, on the cumulative distribution curve of the powder particle size and the particle sizes are classified by increasing order.

### TECHNICAL FIELD

Thermal barrier coatings, or TBCs, are thermal insulation coatings. Although generally porous, TBCs may be dense and in this case may be cracked vertically (DVC: “dense and vertically cracked”).

The invention relates to a feed powder intended to be deposited by plasma spraying to form a TBC, a method for making said feed powder, and a body coated with a TBC obtained by plasma spraying of said feed powder.

### PRIOR ART

TBCs are described by H. L. BERSTEIN in “High temperature coatings for industrial gas turbine users”, Proceedings of the 28th symposium “Turbomachinery”. Conventionally, a TBC consists of zirconia partially stabilized with about 8 wt % of yttria or magnesia applied by electron beam physical vapor deposition (EBPVD), or deposited by thermal spraying, and notably by air plasma spraying.

A TBC conventionally has a thickness between 3 and 15 mm.

Conventionally, it is disposed on a bonding layer consisting of NiCrAlY, itself deposited on a metallic substrate. The bonding layer improves the adhesion of the TBC. The TBC advantageously insulates the metallic substrate from the hot gases of the environment, notably by providing thermal insulation.

TBCs are thus commonly used for protecting the components of gas turbines from oxidation and corrosion at high temperature.

However, under the effects of thermal cycling and corrosion, TBCs may be subject to spalling.

Deposition by EBPVD leads to a columnar microstructure oriented approximately perpendicularly to the surface of the substrate, i.e. “vertically”. This microstructure has good resistance to spalling.

Deposition by EBPVD is, however, much more expensive than deposition by thermal spraying. Moreover, a TBC obtained by thermal spraying has lower thermal conductivity than a TBC obtained by EBPVD. It therefore constitutes a more effective thermal barrier. Conventionally, however, it does not allow vertical cracking to be obtained.

Thermal barrier coatings are known from US 2004/0033884 or from U.S. Pat. No. 6,893,994. However, they are not vertically cracked.

Vertically cracked coatings are known from WO2007/139694, WO2008/054536 or US 2014/0334939. According to the teaching of these documents, coatings based on zirconia strongly stabilized with yttria have little resistance to thermal shocks.

There is thus a permanent need for a vertically cracked TBC coating that can be deposited by plasma thermal spraying, with a high yield, and having an improved compromise between resistance to spalling and capacity for thermal insulation, at constant thickness.

One aim of the invention is to meet this need, at least partially.

### SUMMARY OF THE INVENTION

According to the invention, this aim is achieved by means of a powder (“feed powder” hereinafter) of molten particles (“feed particles” hereinafter), preferably obtained by plasma fusion,

said powder containing, in percentage by weight based on the oxides, more than 98% of a stabilized oxide selected from stabilized zirconium oxides, stabilized hafnium oxides and mixtures thereof, the stabilized oxide being stabilized by a stabilizer selected from the oxides of Y, Ca, Ce, Sc, Mg, In, La, Gd, Nd, Sm, Dy, Er, Yb, Eu, Pr, and Ta, called “stabilizing oxides”, and the mixtures of these stabilizing oxides, said powder having:
a median particle size D₅₀ under 15 μm, a 90th percentile of the particle sizes D₉₀ under 30 μm, and a size dispersion index relative to the 10th percentile of the particle sizes D₁₀, (D₉₀−D₁₀)/D₁₀, less than 2;
a relative density above 90%, preferably above 95%,

the cumulative specific volume of the pores having a radius less than 1 μm preferably being below 10% of the apparent volume of the powder.

“Stabilized oxide” means the oxide, namely zirconium oxide and/or hafnium oxide on the one hand, and the stabilizer on the other hand.

A feed powder according to the invention is therefore a powder that is characterized, in particular, by very low particle size dispersion, relative to D₁₀, by a small amount of particles larger than 30 μm and by a very high relative density.

This last-mentioned characteristic implies a very small amount of hollow particles, or even approximately zero. The granulometric distribution ensures very uniform melting during spraying.

As will be seen in more detail in the rest of the description, a feed powder according to the invention makes it possible, by simple thermal spraying, and in particular by plasma spraying, to obtain a vertically cracked TBC coating giving both very good thermal insulation and high resistance to thermal cycling.

A feed powder according to the invention may also comprise one or more of the following optional characteristics:
More than 95%, preferably more than 99%, preferably more than 99.5% by number of said particles have a circularity greater than or equal to 0.85, greater than or equal to 0.87, preferably greater than or equal to 0.90;
The powder contains more than 99.9%, more than 99.950%, more than 99.990%, preferably more than 99.999% of said stabilized oxide; the amount of other oxides is therefore so small that it cannot have a significant effect on the results obtained with a feed powder according to the invention;
The oxides represent more than 98%, more than 99%, more than 99.5%, more than 99.9%, more than 99.95%, more than 99.985% or more than 99.99% of the weight of the powder;
The percentage by number of particles having a size less than or equal to 5 μm is greater than 5%, preferably greater than 10%;
The percentage by number of particles having a size greater than or equal to 0.5 μm is greater than 10%;
The median size of the particles (D₅₀) of the powder is greater than 0.5 μm, preferably greater than 1 μm, or even greater than 2 μm, and/or less than 13 μm, preferably less than 12 μm, preferably less than 10 μm or less than 8 μm;
The 10th percentile (D₁₀) of the particle sizes is greater than 0.1 μm, preferably greater than 0.5 μm, preferably greater than 1 μm, or even greater than 2 μm;
The 90th percentile (D₉₀) of the particle sizes is less than 25 μm, preferably less than 20 μm, preferably less than 15 μm;
The 99.5 percentile (D_{99.5}) of the particle sizes is less than 40 μm, preferably less than 30 μm;
The size dispersion index (D₉₀−D₁₀)/D₁₀ is preferably less than 1.5; this results advantageously in a higher coating density;
Preferably, the powder has a monomodal type of granulometric dispersion, i.e. a single main peak;
The cumulative specific volume of pores with a radius of less than 1 μm is less than 8%, preferably less than 6%, preferably less than 5%, preferably less than 4%, preferably less than 3.5% of the apparent volume of the powder;
The specific surface of the feed powder is preferably less than 0.4 m²/g, preferably less than 0.3 m²/g.

The invention further relates to a method of making a feed powder according to the invention comprising the following successive steps:
a) granulation of a particulate charge so as to obtain a granular powder having a median size D′₅₀ between 20 and 60 microns, the particulate charge comprising, in percentage by weight based on the oxides, more than 98% of a stabilized oxide selected from stabilized zirconium oxides, stabilized hafnium oxides and mixtures thereof, the stabilized oxide being stabilized by a stabilizer selected from the oxides of Y, Ca, Ce, Sc, Mg, In, La, Gd, Nd, Sm, Dy, Er, Yb, Eu, Pr, and Ta, called “stabilizing oxides”, and mixtures of these stabilizing oxides,
b) injection of said granular powder, by means of a carrier gas, through at least one injection orifice to a plasma jet generated by a plasma gun, in conditions causing break-up before fusion of more than 50%, preferably more than 60%, preferably more than 70%, preferably more than 80%, preferably more than 90% by number of the granules injected, in percentage by number, and then fusion of the granules and fragments of granules so as to obtain droplets,
c) cooling of said droplets, so as to obtain a feed powder according to the invention;
d) optionally, granulometric selection, preferably by sieving or by air classification, of said feed powder.

Violent injection of the powder advantageously allows simultaneous reduction in median size of the feed powder and decrease in the proportion of hollow particles. It thus makes it possible to obtain a very high relative density.

Preferably, the plasma gun has a power above 40 kW, preferably above 50 kW and/or below 65 kW, preferably below 60 kW.

Preferably, the plasma gun has a power between 40 to 65 kW and the ratio of the amount by weight of granules injected per injection orifice, preferably by each injection orifice, to the surface area of said injection orifice is greater than 15, preferably greater than 17, preferably greater than 20, preferably greater than 23 g/min per mm² of surface area of said injection orifice and/or less than 30 g/min per mm² of surface area of said injection orifice.

The injection orifice, preferably each injection orifice, preferably consists of a channel whose length is greater than once, preferably twice, or even 3 times the equivalent diameter of said injection orifice.

Preferably, the flow rate of the granular powder injected is less than 2.4 g/min, preferably less than 2 g/min per kW of power of the plasma gun.

There is no intermediate sintering step, and preferably no consolidation between steps a) and b). This absence of an intermediate consolidation step advantageously improves the purity of the feed powder. It also facilitates break-up of the granules in step b).

A method of making a powder according to the invention may also comprise one or more of the following optional features:
In step a), granulation is preferably a method of atomization or spray drying or pelletization (transformation into pellets);
In step a), the mineral composition of the granular powder comprises more than 98.5%, preferably more than 99%, preferably more than 99.5%, preferably more than 99.9%, more than 99.95%, more than 99.99%, preferably more than 99.999% of said stabilized oxide, in percentage by weight based on the oxides;
The median circularity C₅₀ of the granular powder is preferably above 0.85, preferably above 0.90, preferably above 0.95, and more preferably above 0.96;
The 5th percentile of circularity of the granular powder, C₅, is preferably greater than or equal to 0.85, preferably greater than or equal to 0.90;
The median aspect ratio A₅₀ of the granular powder is preferably greater than 0.75, preferably greater than 0.8;
The specific surface of the granular powder is preferably less than 15 m²/g, preferably less than 10 m²/g, preferably less than 8 m²/g, preferably less than 7 m²/g;
The cumulative volume of pores having a radius of less than 1 measured by mercury porosimetry, of the granular powder is preferably less than 0.5 cm³/g, preferably less than 0.4 cm³/g or more preferably less than 0.3 cm³/g;
The apparent density of the granular powder is preferably greater than 0.5 g/cm³, preferably greater than 0.7 g/cm³, preferably greater than 0.90 g/cm³, preferably greater than 0.95 g/cm³, preferably less than 1.5 g/cm³, preferably less than 1.3 g/cm³, preferably less than 1.1 g/cm³;
The 10th percentile (D′₁₀) of the particle sizes of the granular powder is preferably greater than 10 μm, preferably greater than 15 preferably greater than 20 μm;
The 90th percentile (D′₉₀) of the particle sizes of the granular powder is preferably less than 90 preferably less than 80 preferably less than 70 preferably less than 65 μm;
The granular powder preferably has a median size D′₅₀ between 20 and 60 microns;
The granular powder preferably has a percentile D′₁₀ between 20 and 25 μm and a D′₉₀ between 60 and 65 μm;
The 99.5 percentile (D′_{99.5}) of the particle sizes of the granular powder is preferably less than 100 μm, preferably less than 80 preferably less than 75 μm;
The size dispersion index relative to D′₅₀, (D′₉₀−D′₁₀)/D′₅₀, of the granular powder is preferably less than 2, preferably less than 1.5, preferably less than 1.2, more preferably less than 1.1;
In step b), the diameter of each injection orifice is less than 2 mm, preferably less than 1.8 mm, preferably less than 1.7 mm, preferably less than 1.6 mm;
In step b), the injection conditions are equivalent to those of a plasma gun having a power from 40 to 65 kW and generating a plasma jet in which the amount by weight of granules injected by an injection orifice, preferably by each injection orifice, in g/min and per mm² of the surface area of said injection orifice, is above 10 g/min per mm², preferably above 15 g/min per mm²; “equivalent” means “suitable so that the degree of break-up of the granules (number of granules shattered to the number of granules injected) is identical”;
An injection orifice, preferably each injection orifice, defines an injection channel, preferably cylindrical, preferably of circular section, having a length at least once, preferably at least twice, or even three times greater than the equivalent diameter of said injection orifice, the equivalent diameter being the diameter of a disk with the same area as the injection orifice;
In step b), the flow rate of granular powder is less than 3 g/min, preferably less than 2 g/min, per kW of power of the plasma gun;
The flow rate of the carrier gas (per injection orifice (i.e. per “powder line”)) is greater than 5.5 l/min, preferably greater than 5.8 l/min, preferably greater than 6.0 l/min, preferably greater than 6.5 l/min, preferably greater than 6.8 l/min, preferably greater than 7.0 l/min;
The granular powder is injected into the plasma jet at a feed flow rate greater than 20 g/min, preferably greater than 25 g/min, and/or less than 60 g/min, preferably less than 50 g/min, preferably less than 40 g/min, per injection orifice;
The total feed flow rate of granules (cumulative for all the injection orifices) is greater than 70 g/min, preferably greater than 80 g/min, and/or preferably less than 180 g/min, preferably less than 140 g/min, preferably less than 120 g/min, preferably less than 100 g/min;
Preferably, in step c), the cooling of the molten droplets is such that, as far as 500° C., the average cooling rate is between 50 000 and 200 000° C./s, preferably between 80 000 and 150 000° C./s.

The invention also relates to a method of making a vertically cracked TBC coating, said method comprising a step of thermal spraying, preferably by plasma, of a feed powder according to the invention, notably produced by a method according to the invention, on a substrate.

Preferably, the substrate is made of metal. The substrate may be a blade of a propeller or a vane of a gas turbine.

The invention also relates to an object comprising a substrate and a vertically cracked TBC coating covering said substrate at least partially, said TBC coating preferably being separated from the substrate by a bonding layer, preferably of NiCrAlY, and being made by a method according to the invention. This object is in particular very suitable for use in an environment at a temperature above 1200° C.

The coating preferably has a thermal conductivity below 3 W/m.K.

Preferably, said coating comprises more than 98% of said stabilized oxide and preferably has a porosity, measured on a photograph of a polished section of said coating, as described below, less than or equal to 1.5%. Preferably, the porosity of said coating is below 1%.

Preferably, said coating comprises more than 98.5%, preferably more than 99%, preferably more than 99.5%, preferably more than 99.9%, more than 99.95%, more than 99.97%, more than 99.98%, more than 99.99%, preferably more than 99.999% of said stabilized oxide, in percentage by weight based on the oxides.

Said coating may be produced by a method of thermal spraying according to the invention.

The invention further relates to the use of said vertically cracked TBC coating for protecting a component in an environment in which the temperature exceeds 1000° C., 1100° C., 1200° C. or 1300° C.

### Definitions

“Impurities” are the unavoidable constituents introduced unintentionally and necessarily with the raw materials or resulting from the reactions between the constituents. The impurities are not necessary constituents, but only constituents that are tolerated. The level of purity is preferably measured by GDMS (glow discharge mass spectroscopy), which is more accurate than the AES-ICP (inductively coupled plasma-atomic emission spectrometer).
The “circularity” of the particles of a powder is conventionally determined as follows: The powder is dispersed on a flat glass plate. The images of the individual particles are obtained by scanning the dispersed powder under a light microscope, while keeping the particles in position, the powder being illuminated from underneath the glass plate. These images may be analyzed using apparatus of the Morphologi® G3 type marketed by the company Malvern.
As shown in FIG. 4, to evaluate the “circularity” C of a particle P′, we determine the perimeter P_{D} of the disk D having an area equal to the area Aₚ of the particle P′ on an image of this particle. The perimeter Pₚ of this particle is also determined. The circularity is equal to the ratio P_{D}/P_{P}. Thus,

$$C = \frac{2 * \sqrt{π {A}_{p}}}{{P}_{p}} .$$

The more elongated the shape of the particle, the lower the circularity. This procedure is also described in the user manual of the SYSMEX FPIA 3000 (see “detailed specification sheets” on www.malvern.co.uk).
To determine a percentile of circularity (described below), the powder is poured onto a flat glass plate and observed as explained above. The number of particles counted should be greater than 250 for the percentile measured to be approximately identical, regardless of the way in which the powder is poured onto the glass plate.
The aspect ratio A of a particle is defined as the ratio of the width of the particle (its largest dimension perpendicularly to the direction of its length) to its length (its largest dimension).
To determine an aspect ratio percentile, the powder is poured onto a flat glass plate and observed as explained above, to measure the lengths and the widths of the particles. The number of particles counted should be greater than 250 for the percentile measured to be approximately identical, regardless of the way in which the powder is poured onto the glass plate.
The percentiles 10 (M₁₀), 50 (M₅₀), 90 (M₉₀) and 99.5 (M_{99.5}), and more generally “n” Mₙ of a property M of the particles of a particle powder are the values of this property for the percentages, by number, of 10%, 50%, 90%, 99.5% and n %, respectively, on the cumulative distribution curve relating to this property of the particles of the powder, the values relating to this property being classified by increasing order. In particular, the percentiles Dₙ (or D′ₙ for the granular powder), Aₙ, and Cₙ relate to size, aspect ratio and circularity, respectively.

For example, 10%, by number, of the particles of the powder have a size less than D₁₀ and 90% of the particles by number have a size greater than or equal to D₁₀. The percentiles relating to size may be determined by means of a granulometric distribution found using a laser granulometer.
Similarly, 5% by number of particles of the powder have a circularity less than the percentile C₅. In other words, 95% by number of particles of this powder have a circularity greater than or equal to C₅.

Conventionally, the 50th percentile is called the “median” percentile. For example, C₅₀ is called “median circularity” conventionally. Moreover, the percentile D₅₀ is called “median size” conventionally. The percentile A₅₀ also refers conventionally to the “median aspect ratio”.
“Size of a particle” means the size of a particle found conventionally by characterization by granulometric distribution performed with a laser granulometer. The laser granulometer used may be a Partica LA-950 from the company HORIBA.
The percentage or fraction by number of particles having a size less than or equal to a maximum size determined may be determined using a laser granulometer.
The cumulative specific volume of pores with a radius of less than 1 μm, expressed in cm³/g of powder, is measured conventionally by mercury porosimetry according to standard ISO 15901-1. It may be measured with a MICROMERITICS porosimeter.
The apparent volume of powder, expressed in cm³/g, is the inverse of the apparent density of the powder.
The “apparent density” (“bulk density”) P of a particle powder is defined conventionally as the ratio of the weight of the powder divided by the sum of the apparent volumes of said particles. In practice, it may be measured with a MICROMERITICS porosimeter at a pressure of 200 MPa.
The “relative density” of a powder is equal to its apparent density divided by its true density. The true density may be measured by helium pycnometry.
The “porosity” of a coating can be evaluated by image analysis of a polished cross section of the barrier. The coated substrate is sectioned using a laboratory cutting machine, for example using a Struers Discotom apparatus with an alumina-based cutting disk. The specimen of the coating is then mounted in a resin, for example using a cold mounting resin of the Struers Durocit type. The mounted specimen is then polished using polishing media of increasing fineness. Abrasive paper may be used, or preferably polishing disks with a suitable polishing suspension. A conventional polishing procedure begins with leveling the sample (for example with a Struers Piano 220 abrasive disk), then changing the polishing sheets associated with the abrasive suspensions. The abrasive grain size is decreased at each step of fine polishing, with the size of the diamond abrasives beginning for example at 9 microns, then at 3 microns, and ending at 1 micron (Struers DiaPro series). For each size of abrasive grain, polishing is stopped once the porosity observed under the light microscope remains constant. The specimens are cleaned carefully between the steps, for example with water. A final polishing step, after the polishing step with diamond of 1 μm, is carried out using colloidal silica (OP-U Struers, 0.04 μm) together with a sheet of the soft felt type. After cleaning, the polished specimen is ready for observation with the light microscope or with the SEM (scanning electron microscope). Owing to its greater resolution and remarkable contrast, the SEM is preferred for producing images intended to be analyzed. The porosity can be determined from the images using image analysis software (for example ImageJ, NIH), adjusting the thresholding. The porosity is given as a percentage of the surface area of the cross section of the coating.
The “specific surface” is measured conventionally by the BET (Brunauer Emmet Teller) method, as described in the Journal of the American Chemical Society 60 (1938), pages 309 to 316.
The operation of “granulation” is a method of agglomeration of particles using a binder, for example a polymer binder, to form agglomerated particles, which may optionally be granules. Granulation comprises, in particular, atomization or spray drying and/or the use of a granulator or a pelletizer, but is not limited to these methods. Conventionally, the binder is substantially oxide-free.
A “granule” is an agglomerated particle having a circularity of 0.8 or more.
A consolidation step is an operation with the aim of replacing, in the granules, the bonds due to organic binders with diffusion bonds. It is generally carried out by a heat treatment, but without complete fusion of the granules.
The “deposition yield” of a method of plasma spraying is defined as the ratio, in percentage by weight, of the amount of material deposited on the substrate divided by the amount of feed powder injected into the plasma jet.
The “spraying productivity” is defined as the amount of material deposited in unit time.
The flow rates in l/min are “standard”, i.e. measured at a temperature of 20° C., at a pressure of 1 bar.
“Contain” or “comprise” must be understood in a nonlimiting way, unless stated otherwise.
Unless stated otherwise, all the composition percentages are percentages by weight based on the weight of the oxides.
The properties of the powder can be evaluated by the methods of characterization used in the examples.

### BRIEF DESCRIPTION OF THE FIGURES

Other features and advantages of the invention will become clearer on reading the following description and on examining the appended drawings, in which:

FIG. 1 shows schematically step a) of a method according to the invention;

FIG. 2 shows schematically a plasma torch for making a feed powder according to the invention;

FIG. 3 shows schematically a method for making a feed powder according to the invention;

FIG. 4 illustrates the method that is used for evaluating the circularity of a particle.

### DETAILED DESCRIPTION

Method of Making a Feed Powder

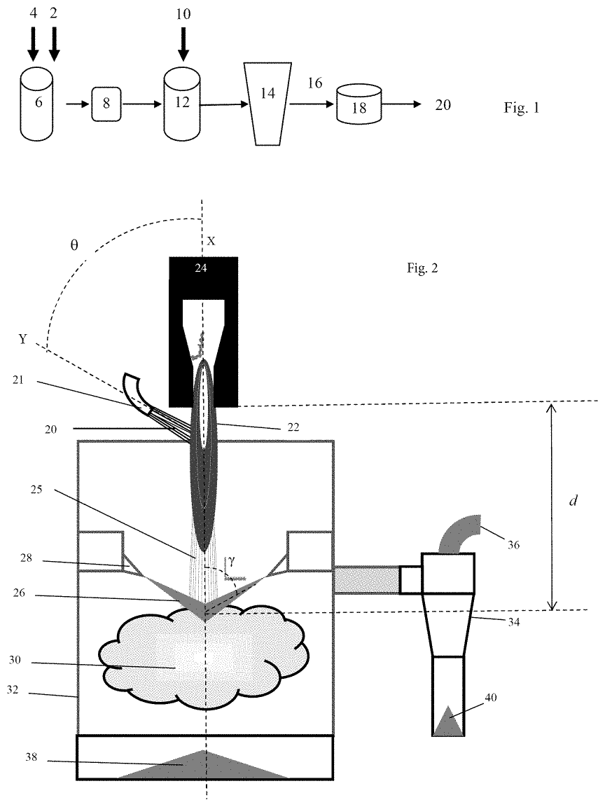

FIG. 1 illustrates an embodiment of step a) of a method of making a feed powder according to the invention.

Any known method of granulation may be used. In particular, a person skilled in the art knows how to prepare a slip suitable for granulation.

In one embodiment, a binder mixture is prepared by adding PVA (polyvinyl alcohol) 2 to deionized water 4. This binder mixture 6 is then filtered through a 5-μm filter 8. A particulate charge, consisting of the powdered stabilized oxide 10 (for example of purity 99.99%), with a median size of 1 μm, is mixed into the filtered binder mixture to form a slip 12. The slip may comprise, by weight, for example 55% of stabilized oxide and 0.55% of PVA, made up to 100% with water. This slip is injected into an atomizer 14 to obtain a granular powder 16. A person skilled in the art knows how to adjust the atomizer to obtain the desired granulometric distribution.

Preferably, the granules are agglomerates of particles of an oxide material having a median size preferably less than 3 μm, preferably less than 2 μm, preferably less than 1.5 μm.

The granular powder may be sieved (5-mm sieve 18, for example) in order to remove any residues that have fallen from the walls of the atomizer.

The resultant powder 20 is a “spray-dried only” (SDO) granular powder.

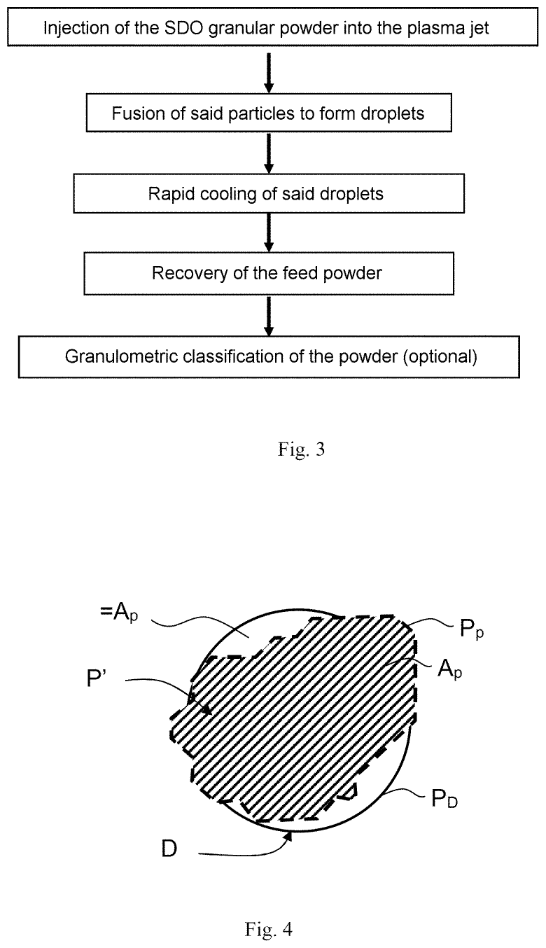

FIGS. 2 and 3 illustrate an embodiment of the fusion step b) of a method of making a feed powder according to the invention.

An SDO granular powder 20, for example as made according to the method illustrated in FIG. 1, is injected by an injector 21 into a plasma jet 22 produced by a plasma gun 24, for example a ProPlasma HP plasma torch. The conventional devices for injection and plasma spraying may be used, for mixing the SDO granular powder with a carrier gas and injecting the resultant mixture into the center of the hot plasma.

However, the granular powder injected must not be consolidated (SDO) and injection into the plasma jet must be done violently, to promote rupture of the granules. The violent nature of the shocks determines the intensity of break-up of the granules, and therefore the median size of the powder produced.

A person skilled in the art knows how to adapt the injection parameters for violent injection of the granules, in such a way that the feed powder obtained at the end of steps c) or d) has a granulometric distribution according to the invention.

In particular, a person skilled in the art knows that:
approximation of the angle of injection θ between the injection axis of the granules Y and the axis X of the plasma jet to 90°,
an increase in the flow rate of powder per mm² of surface area of the injection orifice,
a decrease in the flow rate of powder, in g/min, per kW of gun power, and
an increase in the flow rate of the plasmagene gas are factors that promote rupture of the granules.

In particular, WO2014/083544 does not disclose injection parameters allowing rupture of more than 50% by number of the granules, as described in the examples hereunder.

It is preferable to inject the particles quickly so as to disperse them in a very viscous plasma jet flowing at a very high velocity.

When the injected granules come into contact with the plasma jet, they are subjected to violent shocks, which may break them into pieces. For penetration into the plasma jet, the granules to be dispersed, which are not consolidated, and in particular are not sintered, are injected at a high enough velocity so that they have high kinetic energy, but limited to ensure good efficacy of break-up. Absence of consolidation of the granules reduces their mechanical strength, and therefore their resistance to these shocks.

A person skilled in the art knows that the velocity of the granules is determined by the carrier gas flow rate and the diameter of the injection orifice.

The velocity of the plasma jet is also high. Preferably, the flow rate of plasmagene gas is greater than the median value recommended by the torch manufacturer for the selected anode diameter. Preferably, the flow rate of plasmagene gas is greater than 50 l/min, preferably greater than 55 l/min, preferably greater than 60 l/min.

A person skilled in the art knows that the velocity of the plasma jet can be increased by using an anode of small diameter and/or by increasing the flow rate of the primary gas.

Preferably, the flow rate of the primary gas is greater than 40 l/min, preferably greater than 45 l/min.

Preferably, the ratio of the flow rate of secondary gas, preferably dihydrogen (H₂), to the flow rate of plasmagene gas (made up of the primary and secondary gases) is between 20% and 25%.

Of course, the energy of the plasma jet, influenced notably by the flow rate of the secondary gas, must be high enough to cause the granules to melt.

The granular powder is injected with a carrier gas, preferably without any liquid.

In the plasma jet 22, the granules are melted into droplets 25. Preferably, the plasma gun is set so that fusion is substantially complete.

Fusion advantageously makes it possible to reduce the level of impurities.

On leaving the hot zone of the plasma jet, the droplets are cooled rapidly by the surrounding cold air, but also by forced circulation 26 of a cooling gas, preferably air. The air advantageously limits the reducing effect of the hydrogen.

Preferably, the plasma torch comprises at least one nozzle arranged so as to inject a cooling fluid, preferably air, so as to cool the droplets resulting from heating of the granular powder injected into the plasma jet. The cooling fluid is preferably injected downstream of the plasma jet (as shown in FIG. 2) and the angle γ between the path of said droplets and the path of the cooling fluid is preferably less than or equal to 80°, preferably less than or equal to 60° and/or greater than or equal to 10°, preferably greater than or equal to 20°, preferably greater than or equal to 30°. Preferably, the injection axis Y of any nozzle and the axis X of the plasma jet intersect.

Preferably, the angle of injection θ between the injection axis Y and the axis X of the plasma jet is greater than 85°, preferably about 90°.

Preferably, forced cooling is generated by a set of nozzles 28 arranged around the axis X of the plasma jet 22, so as to create a roughly conical or annular flow of cooling gas.

The plasma gun 24 is oriented vertically toward the ground. Preferably, the angle α between the vertical and the axis X of the plasma jet is less than 30°, less than 20°, less than 10°, preferably less than 5°, preferably approximately zero. Advantageously, the flow of cooling gas is therefore perfectly centered relative to the axis X of the plasma jet.

Preferably, the minimum distance d between the external surface of the anode and the cooling zone (where the droplets come into contact with the injected cooling fluid) is between 50 mm and 400 mm, preferably between 100 mm and 300 mm.

Advantageously, forced cooling limits the generation of satellites, resulting from contact between very large hot particles and small particles in suspension in the densification chamber 32. Moreover, a cooling operation of this kind makes it possible to reduce the overall size of the processing equipment, in particular the size of the collecting chamber.

Cooling of the droplets 25 makes it possible to obtain feed particles 30, which can be extracted in the lower part of the densification chamber 32.

The densification chamber may be connected to a cyclone 34, the exhaust gases from which are directed to a dust collector 36, so as to separate very fine particles 40. Depending on the configuration, some feed particles according to the invention may also be collected in the cyclone. Preferably, these feed particles may be separated, in particular with an air classifier.

Optionally, the feed particles collected 38 may be filtered, so that the median size D₅₀ is less than 15 microns.

Table 1 below gives the preferred parameters for making a feed powder according to the invention.

The characteristics in one column are preferably, but not necessarily, combined. The characteristics of both columns may also be combined.

TABLE 1
Step b)

| | Preferred characteristics | | Even more preferred | |
|---|---|---|---|---|
| | | | characteristics | |
| Gun | High-performance gun with | | ProPlasma HP gun | |
| | low wear (for processing the | | | |
| | powder without | | | |
| | contaminating it) | | | |
| Anode | Diameter >7 mm | | HP8 anode (8 mm diameter) | |
| Cathode | Doped-tungsten cathode | | ProPlasma cathode | |
| Gas injector | Injection partially radial | | ProPlasma HP setup | |
| | (“swirling gas injection”) | | | |
| Current | 500-700 | A | 650 | A |

| | | | |
|---|---|---|---|
| Power | >40 | kW | >50 kW, preferably |
| | | | about 54 kW |

| Nature of the primary gas | Ar or N₂ | Ar | |
|---|---|---|---|
| Flow rate of the primary gas | >40 l/min, | 50 | l/min |
| | preferably >45 l/min | | |

| | | |
|---|---|---|
| Nature of the secondary gas | H₂ | H₂ |
| Flow rate of the secondary gas | >20 vol % of the plasmagene | 25 vol % of the plasmagene |
| | gas mixture | gas mixture |

Injection of the granular powder

| Total flow rate of injected powder | <180 g/min | | <100 | g/min |
|---|---|---|---|---|
| (g/min)(3 injection orifices) | (preferably <60 g/min | | | |
| | per injector) | | | |
| Flow rate in g/min per kW of power | <5 | | <2 | |
| Diameter of the injection orifices | <2 mm | | <1.5 | mm |
| (mm) | preferably <1.8 mm | | | |
| Flow rate in g/min per mm² of | >10 | | >15 and <20 | |
| surface area of injection orifice | | | | |
| Nature of the carrier gas | Ar or N₂ | | Ar | |
| Flow rate of the carrier gas per | >6.0 l/min, | | ≥7.0 | l/min |
| injection orifice | preferably >6.5 l/min | | | |
| Angle of injection relative to the | >85° | | 90° | |
| axis X of the plasma jet | | | | |
| (angle θ in FIG. 2) | | | | |
| Distance between an injection | >10 | mm | >12 | mm |
| orifice and the axis X of the plasma | | | | |
| jet | | | | |

Cooling of the droplets

| Cooling parameters | Conical or annular air curtain, | | | |
|---|---|---|---|---|
| | oriented downstream of the plasma jet | | | |
| Angle γ between the direction of | Downstream of the plasma | | Downstream of the plasma jet, | |
| injection of the cooling fluid, from a | jet, ≥10° | | ≥30° and <60° | |
| nozzle, and the axis X of the plasma | | | | |
| jet | | | | |
| Total flow rate of the forced cooling | 10-70 | Nm³/h | 35-50 | Nm³/h |
| fluid | | | | |
| Flow rate of the exhaust gas | 100-700 | Nm³/h | 250-500 | Nm³/h |

The “ProPlasmaHP” plasma torch is sold by Saint-Gobain Coating Solutions. This torch corresponds to torch T1 described in WO2010/103497.

### Examples

The following examples are supplied for purposes of illustration and do not limit the scope of the invention.

The feed powders 1 and 2 according to the invention and comparative 1 were made with a plasma torch similar to the plasma torch shown in FIG. 2 of WO2014/083544, starting from a source of zirconia powder yttriated at 8 wt %, called “zirconia powder” hereinafter, having a median size D₅₀ of 1.5 micron, measured with a Microtrac laser particle analyzer.

In step a), a binder mixture is prepared by adding PVA (polyvinyl alcohol) binder 2 (see FIG. 1) to deionized water 4. This binder mixture is then filtered through a 5-μm filter 8. The powdered zirconia 10 is mixed into the filtered binder mixture to form a slip 12. The slip is prepared so as to comprise, in percentage by weight, 55% of zirconia powder and 0.55% of PVA, the balance to 100% being deionized water. The slip is mixed intensively using a high shear rate mixer.

The granules are then obtained by atomization of the slip, using an atomizer 14. In particular, the slip is atomized in the chamber of a GEA Niro SD 6,3 R atomizer, the slip being introduced at a flow rate of about 0.381/min.

The speed of the rotating atomizing wheel, driven by a Niro FS1 motor, is set so as to obtain the targeted sizes of the granules 16.

The air flow rate is adjusted to maintain the inlet temperature at 295° C. and the outlet temperature close to 125° C. so that the residual moisture content of the granules is between 0.5% and 1%.

The granular powder is then sieved with a sieve 18 in order to extract the residues therefrom and obtain SDO granular powder 20.

In step b), the granules from step a) are injected into a plasma jet 22 (see FIG. 2) produced with a plasma gun 24. The injection and fusion parameters are given in Table 2 below.

In step c), for cooling the droplets, seven Silvent 2021L nozzles 28, sold by Silvent, were fixed on a Silvent 463 annular nozzle holder, sold by Silvent. The nozzles 28 are spaced regularly along the annular nozzle holder, so as to generate an approximately conical air stream.

TABLE 2

| | |
|---|---|
| Treatment of the powder | Spray dried + plasma spraying |

Granules (particles obtained after spray drying)

| | |
|---|---|
| Type of granules | Spray-dried powder of yttriated zirconium oxide |
| Granules D₁₀ (μm) | 25.8 |
| Granules D₅₀ (μm) | 42.1 |
| Granules D₉₀ (μm) | 66.1 |
| Average bulk density | 1.2 |

Step b): injection

| Total feed flow rate of granules | 90 g/min | 120 | g/min |
|---|---|---|---|
| Flow rate in g/min per kW of gun power | 1.7 | 2.5 | |
| Number of injection orifices (powder lines) | 2 | 3 | |
| Angle θ of injection relative to | 90° (normal to the jet) | 80° downstream | |
| the X axis of the plasma jet | | | |
| (FIG. 2) | | | |
| Distance of each injector | 12 mm | 12 | mm |
| (radially from gun axis) | | | |
| Diameter of the injection orifice | 1.5 mm | 2.0 | mm |
| of each injector | | | |
| Flow rate of the argon carrier | 7.0 l/min | 4.0 | l/min |
| gas per injection orifice | | | |

| | | |
|---|---|---|
| Flow rate in g/min per mm² | 25.5 | 12.7 |
| of surface area of injection orifice | | |

Step b): fusion

| Plasma gun | ProPlasma HP | | |
|---|---|---|---|
| Diameter of the anode of the plasma gun | 8 mm | | |
| Voltage (V) | 83 | 74 | |
| Power (kW) | 54 | 48 | |
| Plasmagene gas mixture | Ar + H2 | | |
| Flow rate of the plasmagene gas | 67 l/min | 48 | l/min |
| Proportion of H₂ in the plasmagene gas | 25% | | |
| Nature of the primary gas | Ar | | |
| Calculated flow rate of the primary gas | 50 l/min | 36 | l/min |

| | |
|---|---|
| Current intensity of the plasma arc | 650 A |

Step c): cooling

| Annular cooling nozzles | 7 nozzles Silvent 2021 L fixed Silvent 463 | |
|---|---|---|
| Total flow rate of cooling air (Nm³/h) | 20 | 20 |
| Air flow rate in the cyclone (Nm³/h) | 650 | 650 |

Step d): granulometric selection

| | | | |
|---|---|---|---|
| Upper threshold of granulometric selection | 20 microns | 10 microns | No selection |
| | (by sieving) | (air classif.) | |
| Lower threshold of granulometric selection | 5 microns | 2.5 microns | No selection |
| | (air classif.) | (air classif.) | |

Feed particles collected (feed powder)

| | | | |
|---|---|---|---|
| Reference | Invention 1 | Invention 2 | Comparative 1 |
| D₁₀ (μm) | 7.5 | 3.2 | 19.2 |
| D₅₀ (μm) | 15.1 | 6.5 | 37.7 |
| D₉₀ (μm) | 18.3 | 9.2 | 62.2 |
| (D₉₀ − D₁₀)/ | 1.4 | 1.9 | 2.2 |
| D₁₀ | | | |
| Fraction by number: ≤10 μm (%) | 23 | 100 | 2 |
| Fraction by number: ≤5 μm (%) | 0 | 34 | 1 |
| Relative density calculated in % | 91 | 92 | 81 |
| after mercury porosimetry | | | |
| at a pressure of 200 MPa | | | |

The cumulative specific volume of the pores having a radius less than 1 μm, in the granules, was 340.10⁻³ cm³/g.

The tests show that a feed powder according to the invention has a relative density greater than 90%.

The invention thus supplies a feed powder having a size distribution and a relative density that give the coating a very high density. Furthermore, this feed powder may be effectively sprayed by plasma, with good productivity.

The powder according to the invention makes it possible to produce coatings with a lower concentration of defects, in particular horizontal cracks. Moreover, such a powder has improved flowability relative to a powder not fused by plasma of the same size, which allows injection without complex feeding means.

Of course, the invention is not limited to the embodiments described and presented.

1. A powder of fused particles,
said powder containing, in percentage by weight based on the oxides, more than 98% of a stabilized oxide selected from stabilized zirconium oxides, stabilized hafnium oxides and mixtures thereof, the stabilized oxide being stabilized by a stabilizer selected from the oxides of Y, Ca, Ce, Sc, Mg, In, La, Gd, Nd, Sm, Dy, Er, Yb, Eu, Pr, and Ta, called “stabilizing oxides”, and the mixtures of these stabilizing oxides,
said powder having:
a median particle size D₅₀ under 15 μm, a 90th percentile of the particle sizes, D₉₀, under 30 μm, and a size dispersion index (D₉₀−D₁₀)/D₁₀ below 2;
a relative density above 90%,
the percentiles Dₙ of the powder being the particle sizes corresponding to the percentages, by number, of n %, on the cumulative distribution curve of the powder particle size, the particle sizes being classified by increasing order.

2. The powder as claimed in claim 1, having:
a percentage by number of particles having a size less than or equal to 5 μm that is greater than 5%, and/or
a median size of the particles D₅₀ below 10 μm, and/or
a 90th percentile of the particle sizes D₉₀ below 25 μm, and/or
a 99.5 percentile of the particle sizes D_{99.5} below 40 μm, and/or
a size dispersion index (D₉₀−D₁₀)/D₁₀ below 1.5.

3. The powder as claimed in claim 1, in which the median size of the particles D₅₀ is below 8 μm.

4. A method of making a powder as claimed in claim 1, said method comprising the following steps:
a) granulation of a particulate charge so as to obtain a granular powder having a median size D′₅₀ between 20 and 60 microns, the particulate charge comprising, in percentage by weight based on the oxides, more than 98% of a stabilized oxide selected from stabilized zirconium oxides, stabilized hafnium oxides and mixtures thereof, the stabilized oxide being stabilized by a stabilizer selected from the oxides of Y, Ca, Ce, Sc, Mg, In, La, Gd, Nd, Sm, Dy, Er, Yb, Eu, Pr, and Ta, called “stabilizing oxides”, and the mixtures of these stabilizing oxides;
b) injection of said granular powder, by means of a carrier gas, through at least one injection orifice into a plasma jet generated by a plasma gun, in conditions causing break-up of more than 50% by number of the granules injected, in percentage by number, so as to obtain molten droplets;
c) cooling said molten droplets, so as to obtain a feed powder as claimed in claim 1;
d) optionally, granulometric selection of said feed powder.

5. The method as claimed in claim 4, in which the injection conditions are determined such as to cause break-up of more than 70% of the granules injected, in percentage by number.

6. The method as claimed in claim 5, in which the injection conditions are determined such as to cause break-up of more than 90% of the granules injected, in percentage by number.

7. The method of making a powder as claimed in claim 4, in which, in step b), the injection conditions are adjusted to cause a degree of break-up of the granules identical to a plasma gun having a power from 40 to 65 kW and generating a plasma jet in which the amount by weight of granules injected by each injection orifice, in g/min and per mm² of the surface area of said injection orifice is above 10 g/min per mm².

8. The method as claimed in claim 7, in which the amount by weight of granules injected by each injection orifice, in g/min and per mm² of the surface area of said injection orifice is above 15 g/min per mm².

9. The method of making a powder as claimed in claim 4, in which said injection orifice defines an injection channel having a length at least once greater than the equivalent diameter of said injection orifice.

10. The method as claimed in the claim 9, in which said length is at least twice greater than said equivalent diameter.

11. The method of making a powder as claimed in claim 4, in which, in step b), the flow rate of granular powder is below 3 g/min per kW of power of the plasma gun.

12. The method as claimed in claim 4, in which granulation comprises atomization.

13. A method of making a dense, vertically cracked thermal barrier coating, said method comprising a step of plasma spraying, on a substrate, of a powder as claimed in claim 1.

14. The method as claimed in claim 1, in which the substrate is a propeller blade or a turbine vane.
